(19) United States
(12) Patent Application Publication
(10) Pub. No.: US 2013/0085692 A1
(43) Pub. Date: Apr. 4, 2013

(54) POWER MEASURING SYSTEM

(71) Applicants: Hyun Suk LEE, Gyeonggi-do (KR); Won Jin BAEK, Gyeonggi-do (KR); Yun Hee LEE, Gyeonggi-do (KR)

(72) Inventors: Hyun Suk LEE, Gyeonggi-do (KR); Won Jin BAEK, Gyeonggi-do (KR); Yun Hee LEE, Gyeonggi-do (KR)

(73) Assignee: Samsung Electro-Mechanics Co., Ltd., Suwon (KR)

(21) Appl. No.: 13/607,969

(22) Filed: Sep. 10, 2012

(30) Foreign Application Priority Data
Sep. 30, 2011 (KR) 10-2011-0100216

(51) Int. Cl. G06F 19/00

(52) U.S. Cl. 702/61

(57) ABSTRACT

Disclosed herein is a power measurement system capable of power of electric devices without performing a quantization process through a separate analog-digital converter for voltage. The power measurement system includes a smart meter measuring a voltage root mean square value input to an electrical device; and a power measurement device measuring power of the electrical equipment using a voltage root mean square value Vrms measured by the smarter meter and a current instantaneous values of power lines connected to the electric device.

### CROSS REFERENCE(S) TO RELATED APPLICATIONS

This application claims the benefit under 35 U.S.C. Section 119 of Korean Patent Application Serial No. 10-2011-0100216, entitled “Power Measuring System” filed on Sep. 30, 2011, which is hereby incorporated by reference in its entirety into this application.

### BACKGROUND OF THE INVENTION

1. Technical Field

The present invention relates to a power measuring system, and more particularly, to a power measuring system measuring power of electrical devices without requiring a separate analog-digital converter for quantizing voltage signals.

2. Description of the Related Art

Power for operating electrical products such as consumer equipment used in a home, business machines used in an office, or the like, is generally supplied by in an order of power plants, transmission lines, and distribution lines that are operated in the Korea Electric Power Corporation.

This power supply method has characteristics of a centralized power supply rather than a distributed power supply, has a radiant structure diffused from a center to a peripheral portion, and has characteristics based on a uni-directional supplier rather than being based on a demander.

In addition, the technology is based on an analog or electromechanical scheme and thus, the power supply should be manually recovered and facilitates should be also manually recovered if an accident occurs.

As a result, in order to increase energy efficiency, research into a smart grid (intelligent power grid) has been actively progressed. The smart grid means the next-generation power system implemented by fusing and combining a modernized power technology and an information communication technology and a management system thereof.

The smart grid is to overcome inefficiency of the centralized and uni-directional power grid that is currently used. The smart grid is based on distributed power system as a core concept. Since various distributed power suppliers have been introduced based on new renewable energy, the smart grid can flexibly distribute and independently operate according to a scale and is an intelligent power grid having sensors and meters mounted in each grid and reacting in real time according to a consumer demand.

Therefore, the power grid fuses the existing power network and the information communication technology for a consumer and a producer to exchange real-time information in two ways, thereby equivalently managing the demand and supply of power to efficiently producing power, obtaining information regarding a power usage in real time, automatically controlling power use time and power usage, diversifying power, or the like.

In order to implement power supply situation, a peak load rate, and demand reaction that allows a user to control the use of consumer equipment according to power production/supply price, a distribution of a smart meter receiving variable power price signals and transferring current demand may be expanded. In addition, smart consumer equipment capable of controlling power usage or used time is needed within home.

In order to satisfy the functions corresponding to the requirements in the smart consumer equipment, a need exists for a power measuring system for measuring power needed for each device.

The power measuring system according to the related art includes a unit for measuring voltage transferred to each consumer equipment and a unit for measuring current. Each of the voltage value and the current value measured by the above-mentioned units is output to an analog-digital converter.

The analog-digital converter converts each of the voltage value and the current value into digital signals so as to be used in an operation process of a microprocessor unit and then, outputs the digital signals to the microprocessor unit.

Then, power consumption of each consumer equipment such as active/reactive power or frequency, or the like, is measured by removing a phase error generated within the system itself using a phase shifter, or the like, and then, using a digital signal value for the voltage and current in the microprocessor unit.

However, the power measuring system according to the related art requires the high-performance analog-digital converter for each voltage and current so as to calculate the digital signals required for the operation of the microprocessor unit and therefore, much costs to implement the power measuring system are consumed.

As a result, in measuring the power consumption of the consumer equipment, operation may be increased and complicated and thus, the power consumed in the power measuring system may be increased.

Generally, the digital conversion is performed by using a sigma-delta analog-digital converter. The area is increased in consideration of the sigma delta analog-digital converter characteristics and thus, a size of a system on chip (SoC) may be increased.

### SUMMARY OF THE INVENTION

An object of the present invention is to provide a power measuring system capable of measuring power consumption of consumer equipment without quantization through a separate analog-digital converter for voltage.

According to an exemplary embodiment of the present invention, there is provided a power measurement system, including: a smart meter measuring a voltage root mean square value input to an electrical device; and a power measurement device measuring power of the electrical equipment using a voltage root mean square value Vrms measured by the smarter meter and a current instantaneous values of power lines connected to the electric device.

The power measurement device may include: a current transformer dropping the current instantaneous value of the power lines to the scale measurable level in the analog-digital converter; an analog-digital converter converting the current instantaneous value dropped by the current transformer into a digital signal; a communication unit receiving the voltage root mean square value measured by the smart meter; and a microprocessor unit (MPU) receiving the digital signal output from the analog-digital converter and the voltage root mean square value Vrms output from the communication unit to calculate the power of the electric device according to a predetermined program.

The current transformer may be connected to a live line or a neutral line of the power lines.

The power measurement device may further include: a zero crossing detection unit detecting a zero crossing point for the voltage of the power lines; and a phase error measurement unit receiving the digital signal output from the analog-digital converter and the zero-cross signal output from the zero crossing detection unit to measure a phase error of current and voltage input to the electric device.

The zero crossing detection unit may include a photocoupler including: a light emitting diode of which the anode terminal is connected to the live terminal of the power lines and the cathode terminal is connected to the neutral line to be operated according to the voltage flowing in the live terminal; and a photo transistor turned-on/off according to the operation of the light emitting diode to output the zero crossing signal to the phase error measurement unit.

The microprocessor unit may receive the digital signal output from the analog-digital converter, the voltage root mean square value Vrms output from the communication unit, and the phase error value measured in the phase error measurement unit to measure the power of the electric device.

The microprocessor unit may calculates the power of the electric device according to the following Equation 5 that takes integration for each half period for Equation 4 performing calculation by multiplying the current value corresponding to the digital signal output from the analog-digital converter as in the following Equation 2 by the voltage root mean square value Vrms measured by the smart meter calculated as the following Equation 3 and adds and calculates an integration value for each half-period.

$$\begin{matrix} I = y \sqrt{2} sin ( 2 π ft - θ ) & [ Equation 2 ] \\ V = \{ \begin{matrix}x , & 0 \leq t \leq \frac{1}{2 f} \\ - x , & \frac{1}{2 f} \leq t \leq \frac{1}{f}\end{matrix} & [ Equation 3 ] \\ IV = \{ \begin{matrix}xy \sqrt{2} sin ( 2 π ft - θ ) , & 0 \leq t \leq \frac{1}{2 f} \\ - xy \sqrt{2} sin ( 2 π ft - θ ) , & \frac{1}{2 f} \leq t \leq \frac{1}{f}\end{matrix} & [ Equation 4 ] \\ {\int }_{0}^{\frac{1}{2 f}} xy \sqrt{2} sin ( 2 π ft - θ ) d t + {\int }_{\frac{1}{2 f}}^{\frac{1}{f}} - xy \sqrt{2} sin ( 2 π ft - θ ) d t = - \frac{xy \sqrt{2}}{2 π f} ( cos ( π - θ ) - cos ( θ ) ) + \frac{xy \sqrt{2}}{2 π f} ( cos ( 2 π - θ ) - cos ( π - θ ) ) = \frac{xy \sqrt{2} cos θ}{π f} & [ Equation 5 ]\end{matrix}$$

### BRIEF DESCRIPTION OF THE DRAWINGS

FIG. 1 is a block diagram of an entire power measurement system according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

In addition, terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

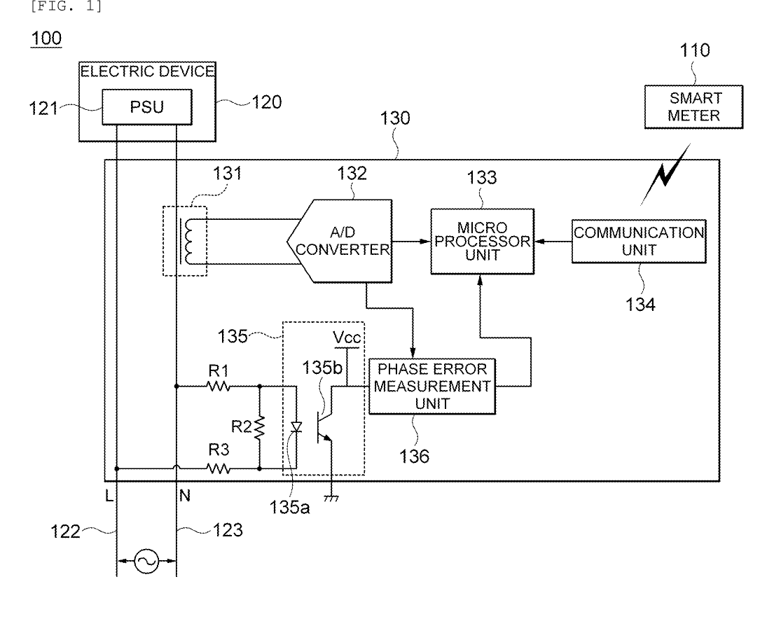

FIG. 1 is a block diagram of an entire power measurement system 100 according to an exemplary embodiment of the present invention.

Referring to FIG. 1, the power measurement system 100 according to the exemplary embodiment of the present invention may include a smart meter 110 measuring a voltage root mean square value input to an electrical device 120 and a power measurement device 130 measuring power of the electrical equipment 120 using a voltage root mean square value Vrms measured by the smarter meter 110 and a current instantaneous values of power lines 122 and 123 connected to the electric device 120.

The electrical device 120 may mean consumer equipment disposed in home and operated by AC power supplied to home or buildings. For example, the consumer equipment may include a refrigerator used at all times and all the consumer equipments used for a predetermined time so as to achieve a predetermined purpose rather than being used at all times such as a computer, a monitor, a printer, a scanner, a TV, a VCR, a microwave oven, a washing machine, or the like.

The power lines 122 and 123 may be configured of a live line and a neutral line and may serve to receive power from a power plant (not shown) and again supply the power to a power supply unit (PSU) 121 included in the electric device 120.

It is apparent to those skilled in the art that the power supply unit 121 may be any type of unit capable of supplying power to the electric device 120 such as, for example, a switch mode power supply (SMPS), or the like.

The smart meter 110 is a configuration device of the next-generation power system called the smart grid (intelligent power grid) together with an energy management system (EMS). The smart meter 110 may be disposed in a distribution line entered from power plant operated by Korea Electric Power Corporation to the indoor or building to measure the voltage root mean square value for power transferred from the power plant to the indoor or buildings.

Describing in more detail, the voltage root mean square value measured by the smart meter 110 is a root mean square value (hereinafter, referred to as RMS) for the voltage of power supplied to the power supply unit 121 within the consumer equipment by the power lines 122 and 123 and may be calculated by a square root of an average value that uses a square of periodically fluctuating voltage instantaneous value as one period as the following Equation 1.

$${F}_{rms} ( t ) = \sqrt{\frac{1}{T} {\int }_{{t}_{0}}^{{t}_{0} + T} {f}^{2} ( t ) d t} \qquad [ Equation 1 ]$$

Since the strength of the voltage root mean square value Vrms is not constant and the voltage root mean square value Vrms is periodically changed over time in the case of AC, the root square mean value is a value represented by applying AC voltage to any resistor and changing a magnitude of DC voltage having the same value as power consumed by the resistor, that is, the magnitude of AC voltage into the magnitude of DC voltage performing the same work as the AC voltage, such that a separate analog-digital converter for calculating a digital signal value required fro the power measurement operation of the microprocessor unit is not required when the power of the electric device 120 is measured using the voltage root mean square value Vrms measured by the smart meter 110.

That is, the voltage value of power transferred to each electric device 120 in the indoor through the distribution line from the power plant (not shown) is uniformly managed in a rate by the smart meter 110 without large fluctuation by the smart meter 110 and is equally applied to all the electric devices 120, such that the voltage root mean square value Vrms measured by the smart meter 110 is immediately substituted during the operation process of the microprocessor unit 133 without performing the quantization process on voltage, thereby measuring the power of the electric device 120.

When the power of the electric device 120 is measured according to the above-mentioned method, the separate analog-digital converter for voltage is not required, such that the power measurement system may be designed at low costs, thereby greatly reducing the size of the system on chip (SoC).

Therefore, the operation process may be simplified in measuring the power of the electric device 120, thereby reducing the power consumed in the power measurement system.

However, the current instantaneous value may be varied according to the use pattern of each electric device 120 and the impedance value of the electric device 120 and therefore, needs to be measured for each consumer equipment through the power lines 122 and 123 connected to the electric devices 120, which may be performed in the power measurement system 130.

The power measurement system 130 may measure the power of the electric device 120 using the voltage root mean square value Vrms measured by the smart meter 110 and the current instantaneous value of the power lines 122 and 123 connected to the electric device 120.

Describing the configuration of the power measurement system 130 in more detail, the power measurement system 130 may include a current transformer 131 that drops the current instantaneous value of the power lines 122 and 123 to the scale measurable level in the analog-digital converter 132, a communication unit 134 receiving the voltage root mean square value Vrms measured by the smart meter 110, an analog-digital converter 132 converting the current instantaneous value dropped by the current transformer 131 into the digital signal value, and a microprocessor unit (MPU) 133 receiving a digital signal value output from the analog-digital converter 132 and the voltage root mean square value Vrms output from the communication unit 134 to calculate the power of the electric device 120 and manage and control each circuit unit.

The current transformer (CT) 131 is connected to the live line or the neutral line of the power lines 122 and 123 connected to the electric device 120, thereby serving to dropping the current instantaneous value of power transferred to the electric device 120.

The value input to the analog-digital converter 132 needs to be maintained at a predetermined level measurable in the analog-digital converter 132. In this case, the current value transferred to the electric device 120 through the power lines 122 and 123 represents a high current value of several amperes (A) or more, such that the current transformer 131 is scaled-down as the low current value corresponding to a level measurable in the analog-digital converter 132 so as to normally operate the analog-digital converter 132.

The current instantaneous value dropped by the current transformer 131 may be transferred to the input of the analog-digital converter 132.

Meanwhile, the power measurement system 100 according to the exemplary embodiment of the present invention may connect a shunt resistor to the live line or the neutral line of the power lines 122 and 123 connected to the electric device 120 instead of the current transformer 131 in parallel so as to drop current and may be substituted into other configurations for current dropping well known generally in the art to which the present invention pertains.

The analog-digital converter 132 may serves to convert the analog signal value for the current instantaneous value dropped by the current transformer 131 into the digital signal value and may be transferred to the input of the microprocessor unit 133 (MPU).

The analog signal for the current instantaneous value dropped by the current transformer 131 forms the signal having actually various and fine difference In order to converge the difference, a need exists for a work to confirm whether the analog signal measured through the sampling process is first generated in any form and average the confirmed signal. As described above, averaging the analog signal having the fine difference into the dispersed digital signal having the same level is performed by the analog-digital converter 132.

The communication unit 134 may serve to receive the voltage root mean square Vrms measured by the smart meter 110 from the smart meter 110 and transfer the received voltage root mean square value to the microprocessor unit 133. To this end, the communication unit 134 may support a wireless scheme such as Bluetooth, Zigbee, or the like. Alternatively, the communication unit 134 may communicate with the smart meter 110 by the wired scheme such as a PLC. Meanwhile, although not shown in the drawings, it is apparent to those skilled in the art that the communication system is implemented for communicating with the communication unit 134 even within the smart meter 110.

The microprocessor unit 133 receives the digital signal value output from the analog-digital converter 132 and the voltage root mean square value Vrms output from the communication unit 134, thereby calculating the power of the electric device 120 according to the predetermined programs. In addition, although not shown in the drawings, the calculated value may be stored in the memory such as EEPROM, or the like.

In order to more accurately measure the power, the power measurement system 100 according to the exemplary embodiment of the present invention may further include a zero crossing detection unit 135 detecting a zero crossing point for the voltage of the power lines 122 and 123 and a phase error measurement unit 136 measuring a phase error of current and voltage input to the electric device 120 using the digital signal converted by the analog-digital converter 132 and the zero cross signal output from the zero crossing detection unit 135.

The zero crossing detection unit 135 may include a photocoupler including a light emitting diode 135a of which the anode terminal is connected to the live line of the power lines 122 and 123 and the cathode terminal is connected to the neutral line to be operated according to the voltage flowing in the live terminal and a photo transistor 135b turned-on/off according to the operation of the light emitting diode 135a to output the zero crossing signal to the phase error measurement unit 136.

When current is applied to the light emitting diode 135a, the light emitting diode 135a emits light and the emitted light turns-on the photo transistor 135b to flow current from a collector terminal of the photo transistor 135b to an emitter terminal. When the photo transistor 135b is turned-on, the collector terminal of the photo transistor 135b is connected to a ground and thus, the voltage is 0V, thereby outputting a low level signal to the phase error measurement unit 136.

To the contrary, when current is not applied to the light emitting diode 135a, the light emitting diode 135a does not emit light and the photo transistor 135b maintains the turn-off state. Therefore, the collector terminal of the photo transistor 135b is connected to a constant power supply and thus, voltage becomes 5V, such that the high level signal is output to the phase error measurement unit 136.

According to the operation, the voltage transferred to the electric device 120 through the power lines 122 and 123 is converted into a high/low signal and is output as the input value of the phase error measurement unit 136 and the high/low signal is synchronized with the sampling rate of the analog-digital converter 132 in the phase error measurement unit 136. The phase error measurement unit 136 may measure the phase error based on the sampling difference between zero crossing points of the voltage value of the synchronized high/low signal and the quantized current value received from the analog-digital converter 132.

Meanwhile, in order to divide the high voltage transferred through the power lines 122 and 123, the cathode terminal of the light emitting diode 135a may be connected between the resistors R1 and R2 connected in series and the anode terminal of the light emitting diode 135a may be connected to a resistor R3.

The microprocessor unit 133 receives the digital signal value output from the analog-digital converter 132, the voltage root mean square value Vrms output from the communication unit 134, and the phase error value measured in the phase error measurement unit 136, thereby more accurately calculating the power of the electric device 120 according to the predetermined programs. In addition, although not shown in the drawings, the calculated value may be stored in the memory such as EEPROM, or the like.

A calculation Equation measuring the power of the electric device 120 by the program pre-established in the microprocessor unit 133 will now be described in detail.

The microprocessor unit 133 can calculate the power of the electric device 120 according to the following Equation 5 that takes integration for each half period for Equation 4 performing calculation by multiplying the current value corresponding to the digital signal output from the analog-digital converter 132 as in the following Equation 2 by the voltage root mean square value Vrms measured by the smart meter 110 calculated as the following Equation 3 and adds and calculates an integration value for each half-period.

$$\begin{matrix} I = y \sqrt{2} sin ( 2 π ft - θ ) & [ Equation 2 ] \\ V = \{ \begin{matrix}x , & 0 \leq t \leq \frac{1}{2 f} \\ - x , & \frac{1}{2 f} \leq t \leq \frac{1}{f}\end{matrix} & [ Equation 3 ] \\ IV = \{ \begin{matrix}xy \sqrt{2} sin ( 2 π ft - θ ) , & 0 \leq t \leq \frac{1}{2 f} \\ - xy \sqrt{2} sin ( 2 π ft - θ ) , & \frac{1}{2 f} \leq t \leq \frac{1}{f}\end{matrix} & [ Equation 4 ] \\ {\int }_{0}^{\frac{1}{2 f}} xy \sqrt{2} sin ( 2 π ft - θ ) d t + {\int }_{\frac{1}{2 f}}^{\frac{1}{f}} - xy \sqrt{2} sin ( 2 π ft - θ ) d t = - \frac{xy \sqrt{2}}{2 π f} ( cos ( π - θ ) - cos ( θ ) ) + \frac{xy \sqrt{2}}{2 π f} ( cos ( 2 π - θ ) - cos ( π - θ ) ) = \frac{xy \sqrt{2} cos θ}{π f} & [ Equation 5 ]\end{matrix}$$

Meanwhile, in Equation 3, the reason of using negative voltage root mean square value (−x) is as follows.

The voltage instantaneous value may be calculated by the following Equation 6.

V=x\sqrt{2} sin(2πft−θ) [Equation 6]

Therefore, the positive sign (+) and the negative (−) of the voltage instantaneous value is periodically changed in period t. However, when only the voltage root mean square value x of the positive sign (+) is used for an integration as it is without considering this, the maximum value (max) is actually shown but the integration result value is shown by 0, when the phase error is 0. Therefore, for convenience of integration operation, the power is calculated using the voltage root mean square value having the negative sign (−) in the specific integration interval.

As described above, according to the power measurement system 100 according to the exemplary embodiment of the present invention, the power of the electric device 120 may be measured by using the voltage root mean square Vrms measured by the smart meter 110 without the separate analog-digital converter 132 for voltage, thereby implementing the power measurement system at low costs.

Therefore, in measuring the power of the electric device 120, the operation can be simplified, thereby reducing the power consumed in the power measurement system and reducing the size of the system on chip (SoC).

As set forth above, the power measuring system according to the exemplary embodiments of the present invention can implement the power measuring system at low cost by measuring the power consumption of consumer equipment without performing the quantization process using the separate analog-digital converter for voltage and implement the small-sized system on chip (SoC).

Further, the exemplary embodiments of the present invention can simplify the operation process in measuring the power consumption of consumer equipment to reduce the power consumed in the power measuring system.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A power measurement system, comprising:
a smart meter measuring a voltage root mean square value input to an electrical device; and
a power measurement device measuring power of the electrical equipment using a voltage root mean square value Vrms measured by the smarter meter and a current instantaneous values of power lines connected to the electric device.

2. The power measurement system according to claim 1, wherein the power measurement device includes:
a current transformer dropping the current instantaneous value of the power lines to the scale measurable level in the analog-digital converter;
an analog-digital converter converting the current instantaneous value dropped by the current transformer into a digital signal;
a communication unit receiving the voltage root mean square value Vrms measured by the smart meter; and
a microprocessor unit (MPU) receiving the digital signal output from the analog-digital converter and the voltage root mean square value Vrms output from the communication unit to calculate the power of the electric device according to a predetermined program.

3. The power measurement system according to claim 2, wherein the current transformer is connected to a live line or a neutral line of the power lines.

4. The power measurement system according to claim 2, wherein the power measurement device further includes:
a zero crossing detection unit detecting a zero crossing point for the voltage of the power lines to output a zero crossing signal; and
a phase error measurement unit receiving the digital signal output from the analog-digital converter and the zero-cross signal output from the zero crossing detection unit to measure a phase error of current and voltage input to the electric device.

5. The power measurement system according to claim 4, wherein the zero crossing detection unit includes a photocoupler including:
a light emitting diode of which the anode terminal is connected to the live line of the power lines and the cathode terminal is connected to the neutral line to be operated according to the voltage flowing in the live terminal; and
a photo transistor turned-on/off according to the operation of the light emitting diode to output the zero crossing signal to the phase error measurement unit.

6. The power measurement system according to claim 4, wherein the microprocessor unit receives the digital signal output from the analog-digital converter, the voltage root mean square value Vrms output from the communication unit, and the phase error value measured in the phase error measurement unit to measure the power of the electric device according to the predetermined program.

7. The power measurement system according to claim 6, wherein the microprocessor unit calculates the power of the electric device according to the following Equation 5 that takes integration for each half period for Equation 4 performing calculation by multiplying the current value corresponding to the digital signal output from the analog-digital converter as in the following Equation 2 by the voltage root mean square value Vrms measured by the smart meter calculated as the following Equation 3 and adds and calculates an integration value for each half-period.
$$\begin{matrix} I = y \sqrt{2} sin ( 2 π ft - θ ) & [ Equation 2 ] \\ V = \{ \begin{matrix}x , & 0 \leq t \leq \frac{1}{2 f} \\ - x , & \frac{1}{2 f} \leq t \leq \frac{1}{f}\end{matrix} & [ Equation 3 ] \\ IV = \{ \begin{matrix}xy \sqrt{2} sin ( 2 π ft - θ ) , & 0 \leq t \leq \frac{1}{2 f} \\ - xy \sqrt{2} sin ( 2 π ft - θ ) , & \frac{1}{2 f} \leq t \leq \frac{1}{f}\end{matrix} & [ Equation 4 ] \\ {\int }_{0}^{\frac{1}{2 f}} xy \sqrt{2} sin ( 2 π ft - θ ) d t + {\int }_{\frac{1}{2 f}}^{\frac{1}{f}} - xy \sqrt{2} sin ( 2 π ft - θ ) d t = - \frac{xy \sqrt{2}}{2 π f} ( cos ( π - θ ) - cos ( θ ) ) + \frac{xy \sqrt{2}}{2 π f} ( cos ( 2 π - θ ) - cos ( π - θ ) ) = \frac{xy \sqrt{2} cos θ}{π f} & [ Equation 5 ]\end{matrix}$$
